(19) United States
(12) Patent Application Publication
(10) Pub. No.: US 2016/0335723 A1
(43) Pub. Date: Nov. 17, 2016

(54) METHOD AND COMPUTER NETWORK FOR COORDINATING FINANCIAL ADVISOR TRANSITIONS

(71) Applicant: AdvisorBid, LLC, Richmond, VA (US)

(72) Inventor: Brandon Spottswood, Richmond, VA (US)

(21) Appl. No.: 15/151,985

(22) Filed: May 11, 2016

Related U.S. Application Data
(60) Provisional application No. 62/160,352, filed on May 12, 2015.

(51) Int. Cl. G06Q 40/06

(52) U.S. Cl. CPC G06Q 40/06

(57) ABSTRACT

A system, method, and computer program product directed toward the use of a computer network for the financial services industry where financial advisors, broker/dealers, and custodians can compete for one another's business. The systems, methods and computer products allow for financial advisors to buy a book of a business, sell a book of a business, transition to a new broker/dealer, or locate a new custodian for their clients' assets.

### CROSS-REFERENCE TO RELATED APPLICATIONS

This application claims the priority and benefit of U.S. Patent Application 62/160,352, entitled METHOD AND COMPUTER NETWORK FOR COORDINATING FINANCIAL ADVISOR TRANSITIONS, filed on May 12, 2015, the contents of which are hearby incorporated by reference.

### FIELD OF TECHNOLOGY

The present disclosure relates to a system, process and computer products for allowing financial advisors, broker and/or dealers to coordinate transitions of financial advisors to new broker-dealers and/or custodians over a network and more specifically to a system, process and computer products allowing financial advisors to coordinate transitions of financial advisors' books of business between financial advisors over the Internet.

### BACKGROUND

Current technology lacks an Internet-based system, method and products allowing financial advisors, broker/dealers, and custodians to coordinate transitions of financial advisors to new broker/dealers and/or custodians, or the transitions of financial advisors' books of business. The transition processes and due-diligence investigations related to financial advisor transitions require large amounts of personal and professional information. Therefore, there is a need for systems, methods and products that allow the involved parties to consolidate the massive undertaking of transitioning the large amounts of personal and professional information into one process by utilizing the speed of the Internet.

### BRIEF SUMMARY

The embodiments of the current disclosure rectifies the complications and excessive time requirements of the current, non-Internet-based methods of transitioning financial advisors for a large number of financial advisors, broker/dealers, and custodians. The embodiments of the present disclosure invention provide a single, Internet-based system, method or product to manage transitions of all financial advisors across the financial services industry.

The embodiments of the present disclosure allow financial advisors to create accounts to confidentially share relevant information to solicit bids from broker/dealers, custodians, and other financial advisors as incentive to make transitions from their current broker/dealer. The embodiments of the present disclosure also allow broker/dealers and custodians to share relevant information to attract financial advisors to transition to their firms.

The embodiments of the present disclosure comprise a system to receive a plurality of documents and figures from financial advisors to present to broker/dealers, custodians, and other financial advisors, and a system to receive information from broker/dealers and custodians to present to financial advisors.

Embodiments of the present disclosure transmit information transmitted via a network such as the Internet or World Wide Web, which may be accessed through a website. All confidential or sensitive information may be safeguarded and transmitted via encrypted means.

### BRIEF DESCRIPTION OF THE DRAWINGS

Other objects and features of the present disclosure will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 depicts a flowchart describing an overview of a method consistent with the embodiments of the present disclosure;

FIG. 2 depicts a schematic of a network for facilitating the implementation of the operation of embodiments consistent with the present disclosure;

FIG. 3 shows an embodiment of advisor-broker/dealer (or custodian) bidding process of the present disclosure;

FIG. 4 shows an embodiment of the advisor-advisor bidding process, of the present disclosure;

FIG. 5 depicts an embodiment of a computer system for implementing the systems, processes and products of the present disclosure.

FIG. 6 depicts a flow chart of an alternative embodiment of broker transitioning or sales of a business's books, consistent with the present disclosure.

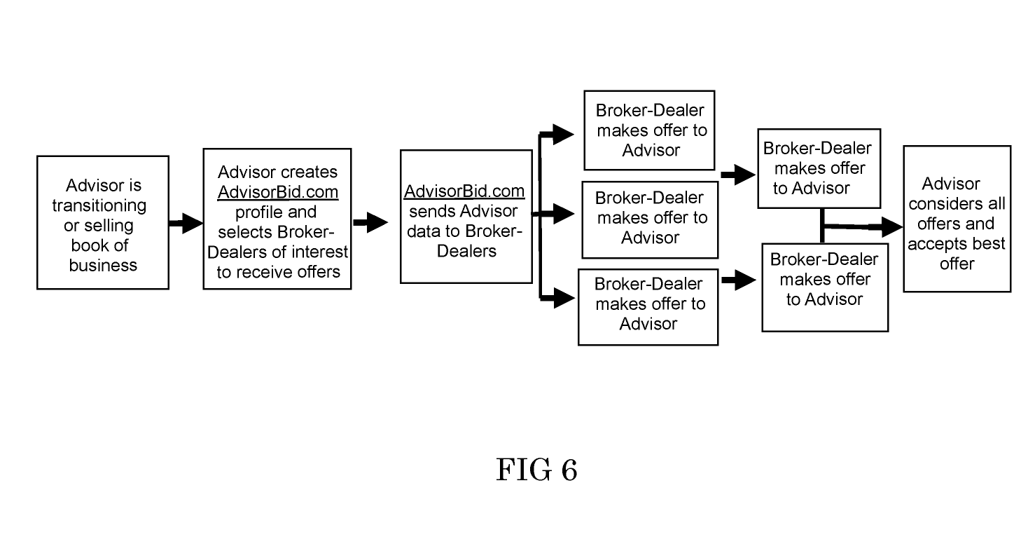

### DETAILED DESCRIPTION

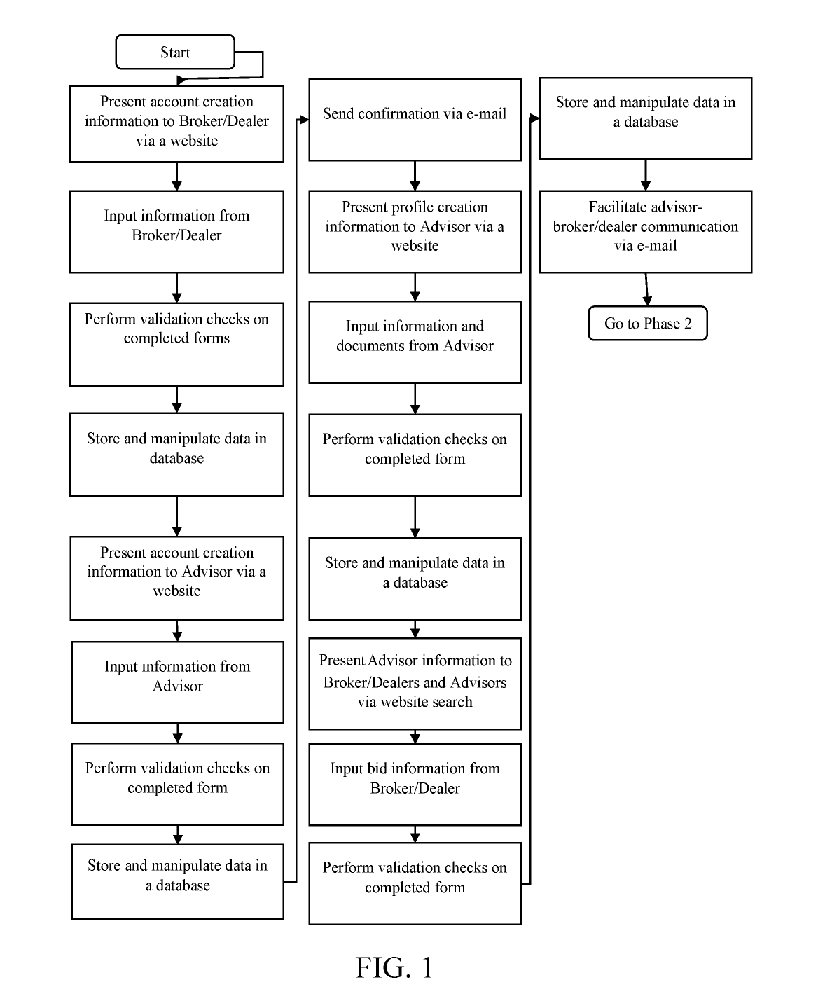

The embodiments of the present disclosure include a system, process and products directed the use of a computer system or programming software loaded in the memory of the computer system, for coordinating financial advisor transitions to new broker/dealers or custodians and the transition of books of business between financial advisors. FIG. 1 illustrates the general stages in an embodiment of the process for facilitating interactions between advisors, broker/dealers and custodians. Firstly, broker/dealers may be presented with a website-based form to input broker/dealer information to create an account. The information submitted is checked for validity with one or more filters and may be stored in a database. Concurrently, advisors may be presented a website-based for to input the advisor's information to create an account, which may be validated using similar filters and stored in a database. A confirmation message maybe sent via email to the advisor, which may provide a web link to a webpage that prompts the advisor for more relevant information and documents verifying the advisor's performance metrics, including but not limited to proof of production statements and non-compete agreements, which may be validated with one or more simple filters and stored in a database. The actions of advisors and broker/dealers are ongoing and concurrent, and one does not necessarily affect the other.

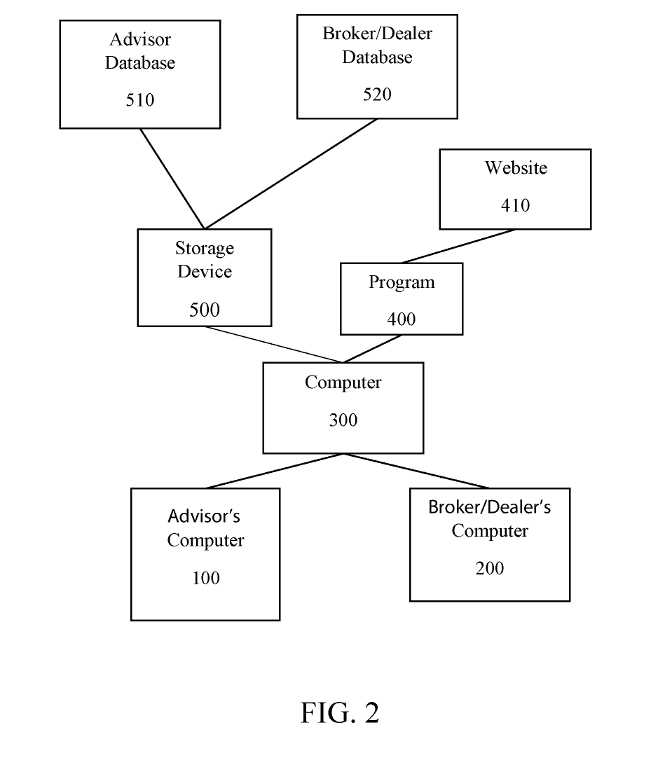

For these processes to occur, there may be a series of computers and storage devices connected to each other via telecommunication lines as shown in FIG. 2. In the embodiment shown in FIG. 2, a computer program 400 controls the process and may be housed on computer 300. A plurality of advisors and custodians may interface with program 400 via a plurality of computer 100, and a plurality of broker/dealers interface with program 400 through a plurality of computer 200. Interfacing between computer 100 and computer 300 and between computer 200 and computer 300 may be performed through website 410. The databases used in the process are database 510 and database 520, which may be stored on storage device 500.

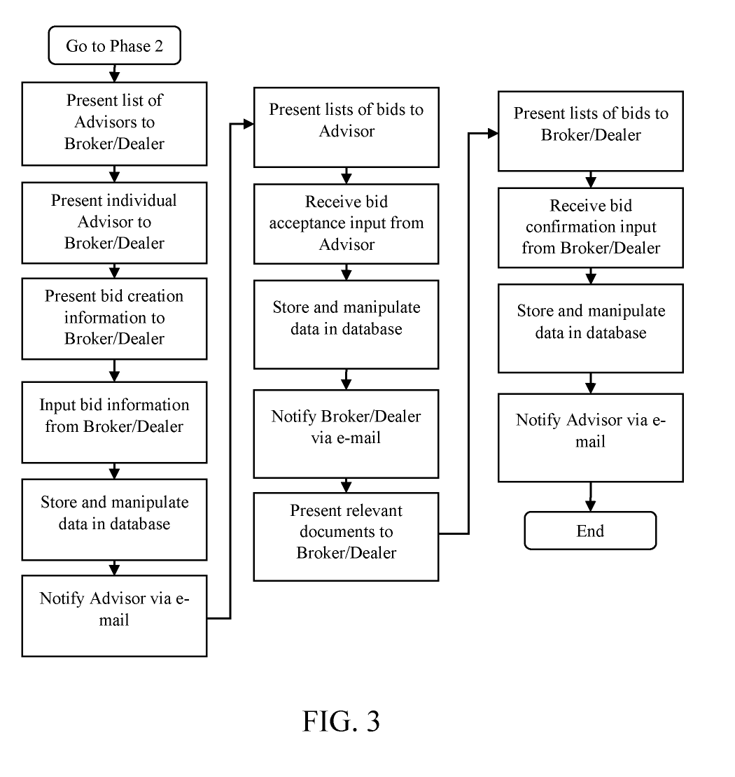

In some embodiments, advisors can be recruited by broker/dealers and custodians as illustrated in FIG. 3. Program 400 queries database 510 and broker/dealers are presented a list of all available advisors using the embodiments of the disclosure as described herein to select and view more data regarding a particular advisor. If the broker/dealer or custodian is satisfied with the credentials of an advisor, the broker/dealer or custodian may choose to bid on the advisor and may be presented a form to input the amount that the broker/dealer or custodian wishes to bid. The information may be validated with one or more filters and stored in database 510. The advisor may be notified via email message, and may be presented the bid and the option to accept the bid or take no action. If the advisor accepts the bid, the related data may be updated in database 510 and an email notification may be sent to the relevant broker/dealer or custodian. Program 400 queries database 510 and the broker/dealer or custodian may be presented the documents and personally-identifying information of the advisor, and is given the option to confirm the bid, withdraw the bid, or take no action. If the bid is confirmed, the transaction is complete and the broker/dealer or custodian may be invoiced the appropriate amount. If the broker/dealer or custodian withdraws the bid, the relevant data is updated in database 510.

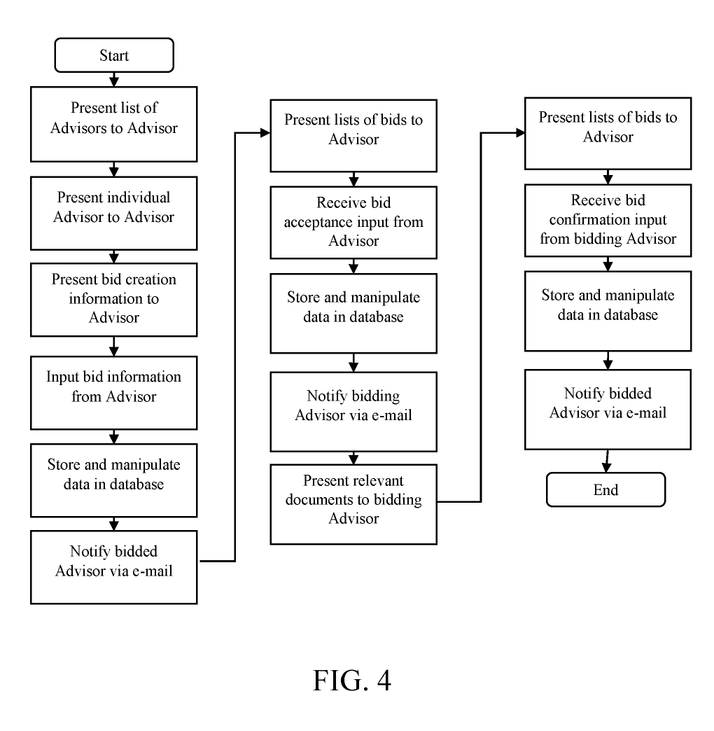

In some embodiments, the custodians, advisors, and broker/dealers can buy books of a business from advisors as illustrated in FIG. 4. Program 400 queries database 510 and bidding advisors or custodians (bidders) are presented a list of advisors that have selected to sell their books of the business (sellers). If a bidder is satisfied with the metrics of a particular book of the business, the bidder can choose to place a bid on the seller's book of business. The bidder may be presented a form to input the amount they wish to bid. The information is validated using one or more filters and stored in database 510. The seller may then be notified via email message and presented the bid amount and the option to accept the bid or take no action. If the seller accepts the bid, the relevant data is updated in the database and the bidder is notified via email message and presented the contact information of the bidder, which ends the transaction.

All operations on website 410 and interactions between computers and with databases 510 and 520 may be encrypted, for example using TLS technology. Interactions between computers 100 and 200 and website 410 may use HTML over an HTTPS protocol. Program 400 may take data from databases 510 and 520 and use PHP Hypertext Preprocessor (PHP) to convert said data to the HTML format to be sent to computers 100 and 200, and may further take all data received from computers 100 and 200 and use PHP to convert that data into queries to store in databases 510 and 520.

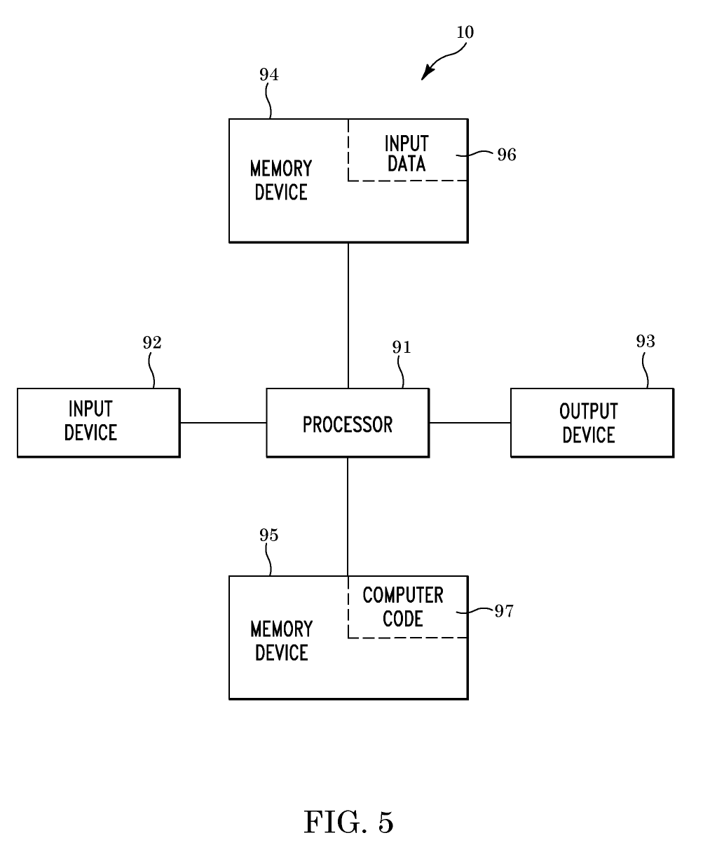

Referring to the drawings, FIG. 5, illustrates a block diagram of a computer system 10 that may part of system as shown in FIG. 2 and/or used for implementing the methods of FIGS. 1, 3 and 4 in accordance with the embodiments of the present disclosure. The computer system 10 may generally comprise a processor 91, an input device 92 coupled to the processor 91, an output device 93 coupled to the processor 91, and memory devices 94 and 95 each coupled to the processor 91. The input device 92, output device 93 and memory devices 94, 95 may each be coupled to the processor 91 via bus. Processor 91 may perform computations and control the functions of computer 10, including executing instructions included in the computer code 97 for transitioning financial advisors or purchasing books of a business from a financial advisor, in the manner prescribed by the embodiments of FIGS. 1, 3 and 4 using the computer systems of FIG. 2, wherein the instructions of the computer code 97 may be executed by processor 91 via memory device 95. The computer code 97 may include software or program instructions that may implement one or more algorithms for implementing the methods of transitioning financial advisors or purchasing books of a business from a financial advisor, as described in detail above. The processor 91 executes the computer code 97. Processor 91 may include a single processing unit, or may be distributed across one or more processing units in one or more locations (e.g., on a client and server).

The memory device 94 may include input data 96. The input data 96 includes any inputs required by the computer code 97. The output device 93 displays output from the computer code 97. Either or both memory devices 94 and 95 may be used as a computer usable storage medium (or program storage device) having a computer readable program embodied therein and/or having other data stored therein, wherein the computer readable program comprises the computer code 97. Generally, a computer program product (or, alternatively, an article of manufacture) of the computer system 10 may comprise said computer usable storage medium (or said program storage device).

Memory devices 94, 95 includes a known computer readable storage medium, including those described in detail below. In one embodiment, cache memory elements of memory devices 94, 95 may provide temporary storage of at least some program code (e.g., computer code 897) in order to reduce the number of times code must be retrieved from bulk storage while instructions of the computer code 97 are executed. Moreover, similar to processor 91, memory devices 94, 95 may reside at a single physical location, including one or more types of data storage, or be distributed across a plurality of physical systems in various forms. Further, memory devices 94, 95 can include data distributed across, for example, a local area network (LAN) or a wide area network (WAN). Further, memory devices 94, 95 may include an operating system (not shown) and may include other systems not shown in FIG. 5.

In some embodiments, the computer system 10 may further be coupled to an Input/output (I/O) interface and a computer data storage unit. An I/O interface may include any system for exchanging information to or from an input device 92 or output device 93. The input device 92 may be, inter alia, a keyboard, a mouse, etc. The output device 93 may be, inter alia, a printer, a plotter, a display device (such as a computer screen), a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 10, and may include any type of transmission link, including electrical, optical, wireless, etc.

An I/O interface may allow computer system 10 to store information (e.g., data or program instructions such as program code 97) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to user monitoring and tracking collaboration between one or more users in a non-computing environment. Thus, an embodiment of the present invention discloses a process for supporting computer infrastructure, where the process includes providing at least one support service for at least one of integrating, hosting, maintaining and deploying computer-readable code (e.g., program code 97) in a computer system (e.g., computer 10) including one or more processor(s) 91, wherein the processor(s) carry out instructions contained in the computer code 97 causing the computer system to monitor user interactions and track collaborations between one or more users occurring in a non-computing environment. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of transitioning financial advisors or purchasing books of a business from a financial advisor. Thus the present invention discloses a process for supporting, deploying and/or integrating computer infrastructure, integrating, hosting, maintaining, and deploying computer-readable code into the computer system 10, wherein the code in combination with the computer system 10 is capable of performing a method for transitioning financial advisors or purchasing books of a business from a financial advisor.

A computer program product of the present invention comprises one or more computer readable hardware storage devices having computer readable program code stored therein, said program code containing instructions executable by one or more processors of a computer system to implement the methods of the present invention.

A computer system of the present disclosure comprises one or more processors, one or more memories, and one or more computer readable hardware storage devices, said one or more hardware storage devices containing program code executable by the one or more processors via the one or more memories to implement the methods of the present disclosure.

The present disclosure may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method for transitioning a financial advisor to a new broker, dealer or custodian, comprising the steps of:
querying, by a computer, a database accessed via a website, comprising a list of financial advisors;
selecting, by the computer, the financial advisor from the list of financial advisors,
bidding, by the computer, an amount for the financial advisor;
notifying, by the computer, the financial advisor of the amount presented during the bidding step;
receiving, by the computer, personally-identifying information about the financial advisor; and
confirming, by the computer, the amount entered during the bidding step.

2. A method for purchasing books of a business from a financial advisor, comprising the steps of:
querying, by a computer, a database accessed via a website, comprising a list of financial advisors selling the books of the business;
selecting, by the computer, the financial advisor associated with the books of the business, from the list of financial advisors;
bidding, by the computer, an amount for the books of the business;
notifying, by the computer, the financial advisor of the amount presented during the bidding step; and
updating, by the computer, a database accessible via the website, to reflect acceptance by the financial advisor of the amount presented during the bidding step.
